(19) United States
(12) Patent Application Publication
(10) Pub. No.: US 2013/0124623 A1
(43) Pub. Date: May 16, 2013

(54) Attention tracking in an online conference

(71) Applicant: Aaron D. Munter, San Francisco, CA (US)

(72) Inventor: Aaron D. Munter, San Francisco, CA (US)

(73) Assignee: Adobe Systems Incorporated, San Jose, CA (US)

(21) Appl. No.: 11/520,317

(22) Filed: Sep. 12, 2006

(51) Int. Cl. H04L 29/06

(52) U.S. Cl. CPC H04L 65/403
USPC 709/204

(57) ABSTRACT

Attention tracking information is received. A function is applied to the attention tracking information to generate a value and a graphical representation of the value is displayed over a time period.

### FIELD OF THE INVENTION

The present invention relates generally to software and, more particularly, to attention tracking in an online conference.

### BACKGROUND

Online conferencing is a set of interactive communication technologies that allow two or more locations to interact, for example, by way of real-time two-way video and audio transmissions. An online conference system typically includes cameras to capture video, speakers to output sounds, and microphones to capture sounds. In an online conference, a participant may communicate and share data with other participants. For example, participants of an online conference can see still or motion video images of each other. In another example, a participant may share texts, audio, images, and video in real time with other participants in the online conference.

It should be appreciated that participants may not pay attention to the online conference in a presentation. Currently, the presenter of the online conference cannot know during the online conference whether participants are paying attention or viewing his presentation. One method to gauge whether participants are paying attention is for the presenter to verbally ask and confirm with each participant whether he is paying attention. However, such verbal confirmation is burdensome to the presenter and disrupts the flow of the online conference. Another method to gauge whether participants are paying attention is to take a survey of the presentation at the end of the online conference. Since the survey is taken at the end of the online conference, the presenter cannot know the effectiveness of his presentation during the online conference. As a result, the presenter cannot take corrective actions during the online conference such that his message is communicated to the other participants.

In view of the foregoing, there is a need for continuing efforts to track attention of participants in an online conference.

### BRIEF DESCRIPTION OF THE DRAWINGS

Various embodiments of the invention are disclosed in the following detailed description and the accompanying drawings.

FIG. 1 is a simplified block diagram of an online conference system, in accordance with an embodiment.

FIG. 2 is a flowchart diagram of a general overview for providing attention tracking information, in accordance with an embodiment.

FIG. 3 is a simplified block diagram of another online conference system, in accordance with another embodiment.

FIG. 4 is a flowchart diagram of another general overview for providing attention tracking information, in accordance with another embodiment.

FIGS. 5A and 5B are various embodiments of graphic user interfaces (GUIs) configured to provide attention tracking information.

FIG. 6 is a diagram of a GUI configured to provide attention tracking information and other information, in accordance with an embodiment.

FIG. 7 is a diagram of a GUI displayed by an online conference application, in accordance with an embodiment.

FIG. 8 is a simplified block diagram of an exemplary computer system that is suitable for processing and executing an online conference application and an attention tracking application, in accordance with an embodiment.

### DETAILED DESCRIPTION

Various embodiments of the invention may be implemented in numerous ways, including as a system, a process, an apparatus, or a series of program instructions on a computer readable medium such as a computer readable storage medium or a computer network where the program instructions are sent over optical or electronic communication links. In general, operations of disclosed processes may be performed in an arbitrary order, unless otherwise provided in the claims.

The embodiments described herein provide methods, devices, systems, and graphic user interfaces for providing attention tracking information in an online conference. A graphical representation of attention tracking information over a time period is displayed during an online conference. As explained in more detail below, the attention tracking information conveys whether one or more participants are paying attention to the online conference. In some embodiments, the graphical representation can be a graph of the attention tracking information over a time period.

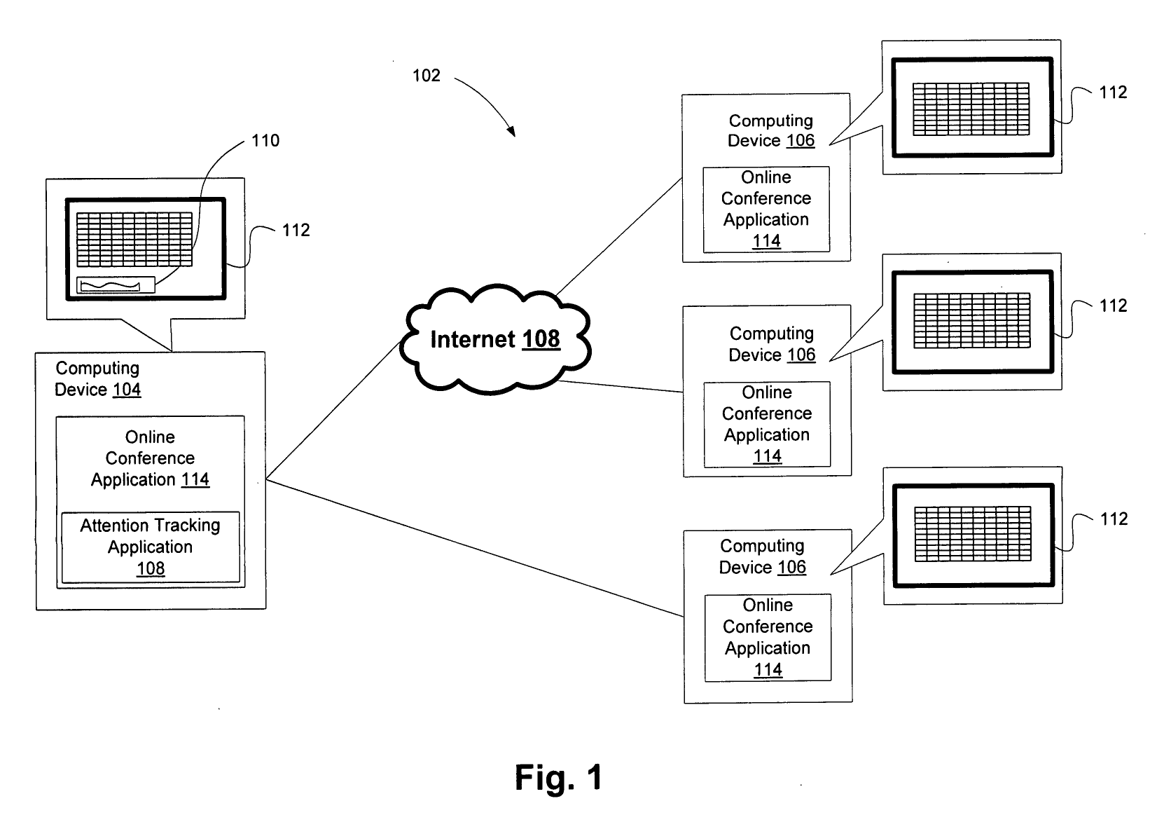

FIG. 1 is a simplified block diagram of an online conference system, in accordance with an embodiment. As shown in FIG. 1, online conference system 102 includes computing device 104 in communication with computing devices 106. Computing devices 104 and 106 may be in communication through a computer network, which can include local area network (LAN), Internet 108, or through other network connections. In general, an online conference may allow two or more applications, such as online conference applications 114, hosted at different locations to interact and/or collaborate by sharing data. Online conference system 102 allows two or more online conference applications 114 hosted on computing devices 104 and 106 to share or communicate data. An example of online conference system 102 includes a video conference system. In a video conference system, computing devices, such as computing devices 104 and 106, may interact with each other by way of simultaneous two-way video and audio transmissions. Such video conference system may include video cameras to capture video, speakers to render audio, and microphones to capture audio. Other online conferences may include multiplayer game sharing, application sharing, whiteboard conferencing, and other online conferences. As shown in FIG. 1, online conference application 114 hosted on computing device 104 may share or communicate data with online conference applications 114 hosted on computing devices 106. For example, online conference application 114 hosted on computing device 104 can transmit image 112 to online conference applications 114 hosted on computing devices 106.

Computing device 104 also hosts attention tracking application 108. Attention tracking application 108 is associated with online conference application 114. For example, attention tracking application 108 may be integrated with online conference application 114. In another example, attention tracking application 108 may be a plug-in application that is loaded into online conference application 114. A plug-in application is a computer program that operates within the confines of online conference application 114. In other examples, attention tracking application 108 may also be a helper object software, a standalone application, or other application types. In the embodiment of FIG. 1, graphical user interface (GUI) 110 is displayed along with image 112. As will be explained in more detail below, attention tracking application 108 is configured to generate GUI 110 that provides attention tracking information over a time period.

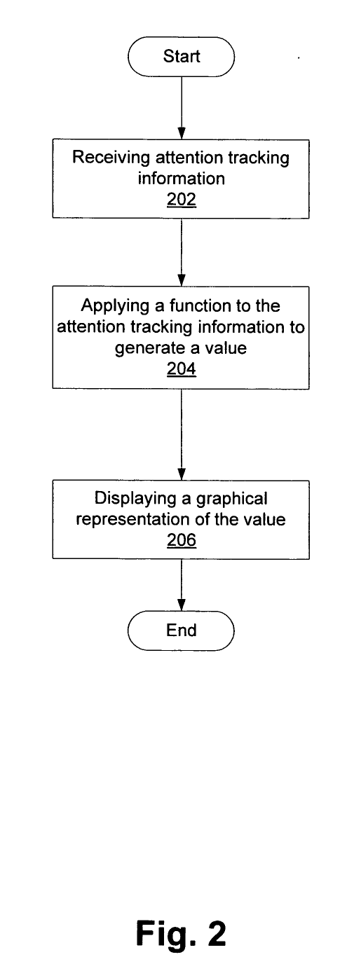

FIG. 2 is a flowchart diagram of a general overview for providing attention tracking information, in accordance with an embodiment. A user in a online conference may look to attention tracking information that are displayed during the online conference to determine whether other users are paying attention to him or viewing the online conference. In the online conference system of FIG. 1, a computing device may host an attention tracking application. As shown in FIG. 2, the attention tracking application receives attention tracking information from one or more online conference applications in operation 202. The attention tracking information is data that is configured to indicate whether a user is paying attention to the online conference. The data may be a binary number, which may be expressed as zero or one, that indicates whether a user is paying attention. For example, a zero can indicate that the user is not paying attention while a one can indicate that the user is paying attention. Alternatively, a one can indicate that the user is not playing attention while a zero can indicate that the user is paying attention. In an embodiment, the attention tracking application may receive the attention tracking information in response to a request for the attention tracking information. In other words, the attention tracking application may send a request for the attention tracking information to online conference applications and, in response, the online conference applications transmit the attention tracking information to the attention tracking application. In another embodiment, the online conference applications may be configured to automatically transmit attention tracking information to the attention tracking application at set periods of time (e.g., every two seconds, every minute, and other periods).

There are a variety of techniques that a computing device can use to determine whether a user is paying attention to the online conference. One technique checks whether the online conference application is placed in a foreground or a background. With the online conference application still running, a user may place the online conference application in the background by minimizing the window associated with the online conference application into an icon. Since the minimized window is represented by an icon, the contents displayed within the window are not visible. A user therefore cannot view or pay attention to the online conference if the contents within the widow are not visible. The computing device may also display other windows associated with other applications. With multiple windows, the user may place the online conference application in the background by placing a window associated with another application in the foreground or in front of the window associated with the online conference application. With the window associated with the other application placed in front, the window associated with the online conference application is blocked from view. In this example, the user also cannot view or pay attention to the online conference since the window associated with the online conference application is blocked from view. Another technique checks whether the audio is muted. For example, if the audio is muted in an online conference with sound, a user cannot hear or pay attention to the online conference. Furthermore, if video cameras are used in an online conference, a facial recognition application may be used to detect the presence of the user in the online conference. A facial recognition application can identify a person from a digital image by comparing selected facial features in an image taken during the online conference with a facial database. With video cameras, eye tracking technologies may also be used to determine where the user is looking by tracking the movements of the eyes. Here, a user may be paying attention to the online conference if his eyes are looking at a monitor. If the user is looking away from the monitor, then the user is not paying attention.

The attention tracking information is configured to indicate whether a user is paying attention to the online conference. With the techniques described above, the attention tracking information can therefore indicate whether the online conference application is placed in the foreground or the background. For instance, the attention tracking information with a one value can indicate that the online conference application is placed in the background. Conversely, the attention tracking information with a zero value can indicate that the online conference application is placed in the foreground.

As discussed above, the attention tracking information indicates whether a user is paying attention to the online conference. Rather than using one attention tracking information received as indication of whether the user is paying attention, the attention tracking application may make a determination of whether the user is paying attention based on multiple attention tracking information received. For example, the attention tracking application may be configured to make a determination when two or more attention tracking information match. Here, the attention tracking application may flag that the user is not paying attention if two consecutive attention tracking information received from one online conference application indicate that the online conference is placed in the background. If the two attention tracking information received do not match (e.g., one attention tracking information indicates that the online conference application is placed the background and the other indicates that the online conference application is placed in the foreground), then the attention tracking application does not flag that the user is not paying attention. The use of multiple attention tracking information to make a determination as to whether a user is paying attention may be more reliable than the use of a single attention tracking information to make the determination. In addition, the attention tracking application may include a buffer to temporarily store the attention tracking information received. The buffer allows the attention tracking application to temporarily store the attention tracking information until enough attention tracking information are received to enable the attention tracking application to make a determination.

After the attention tracking information is received, a function is applied to the attention tracking information in operation 204 to generate a value. A variety of functions may be applied to the attention tracking information. In an embodiment, the value is an aggregate of the attention tracking information. Here, multiple attention tracking information that are associated with a particular time may be summed together. The summation can be expressed as

Σ AttentionTrackingInformation (1.0)

For example, at a particular time, attention tracking information with bit values 0, 1, and 1 are received from three computing devices (or three online conference applications) in an online conference. Applying the function defined in Equation 1.0, the sum of 0, 1, and 1 is 0+1+1=2. If a one value indicates that the user is not playing attention, then the sum indicates that two users are not paying attention to the online conference at a particular time. In another embodiment, the value generated may be a percent value that can be expressed as

$$\frac{\sum AttentionTrackingInformation}{TotalNumber} \qquad ( 2.0 )$$

where TotalNumber is the total number of online conference applications in the online conference. As shown in Equation 2.0, the percent value is defined as a proportion between a sum of the attention tracking information and a total number of online conference applications in an online conference. To generate the percent value, the sum of the attention tracking information is divided by a total number of online conference applications in the online conference. For example, if the sum is two and the total number of online conference applications is three, then two divided by three is 0.67. If an attention tracking information with a one value indicates that the user is not playing attention, then the percent value indicates that 67% of the users are not paying attention to the online conference.

It should be noted that the functions described above, such as Equations 1.0 and 2.0, may be applied to one or more attention tracking information that correspond to different times or to the same time. The time may indicate when the attention tracking information was taken during the online conference. In an embodiment, the time associated with the attention tracking information can be received with the attention tracking information. For example, the attention tracking information may include a time stamp. In another embodiment, the attention tracking application may correlate the attention tracking information with a time. For example, online conference applications may be configured to transmit attention tracking information to an attention tracking application at set periods or intervals. If the set period is one transmission every minute, then the attention tracking application may correlate a first set of attention tracking information received with the first minute of an online conference. Thereafter, the attention tracking application may receive a second set of attention tracking information and the attention tracking application may correlate the second set with the second minute of the online conference. In another example, the attention tracking application may correlate the attention tracking information with the time that the attention tracking information is received.

Still referring to FIG. 2, a graphical representation of the generated value is displayed over a time period in operation 206. The time period spans from the beginning to the end of the online conference. As will be explained in more detail below, in an embodiment, the graphical representation may include a graph of the values over a time period.

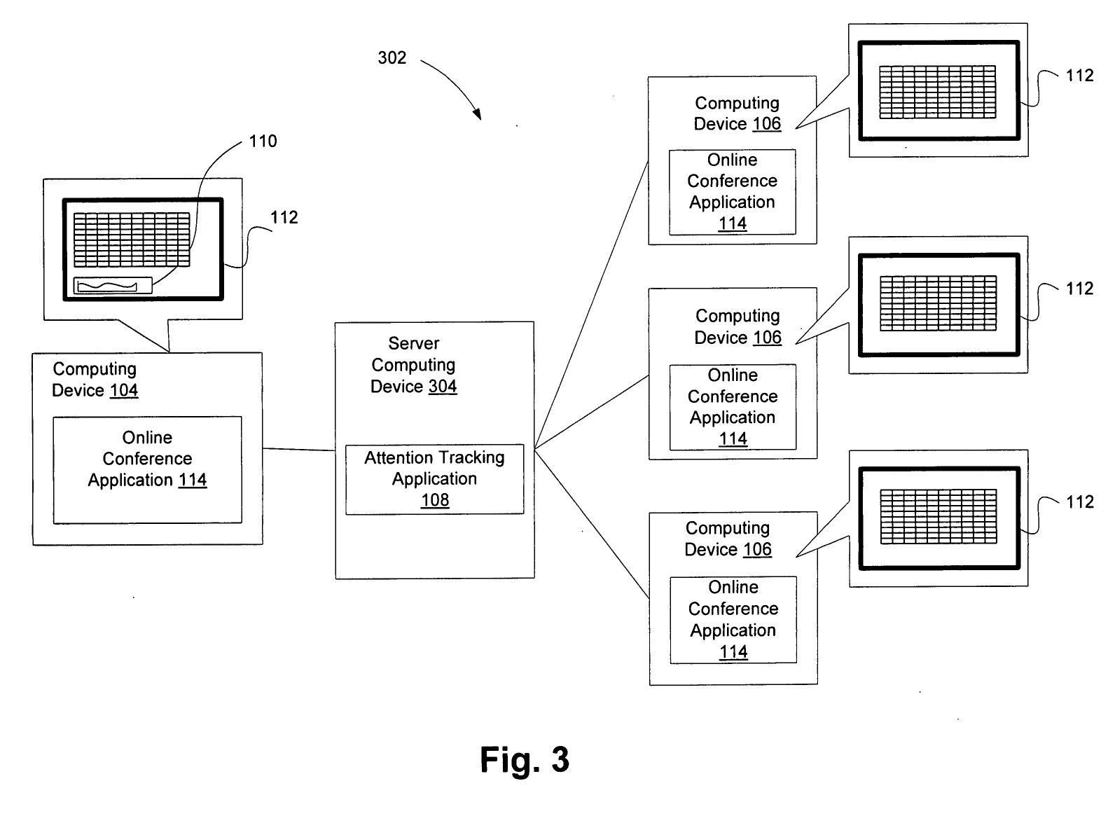

FIG. 3 is a simplified block diagram of another online conference system, in accordance with another embodiment. As shown in FIG. 3, online conference system 302 includes client computing device 104 in communication with client computing devices 106 by way of server computing device 304. Computing devices 104 and 106 and server computing device 304 are in communication through a computer network. Server computing device 304 provides services or data to computing devices 104 and 106. For example, server computing device 304 may include a Web server that is configured to receive Hypertext Transfer Protocol (HTTP) requests and to serve Web pages.

In online conference system 302, online conference applications 114 hosted on computing devices 104 and 106 transmit video, audio, and other data by way of server computing device 304. In the example of FIG. 3, online conference application 114 transmits image 112 to server computing device 304. In turn, server computing device 304 transmits image 112 to online conference applications 114 hosted on computing devices 106. In this embodiment, attention tracking application 108 is hosted on server computing device 304 instead of a computing device used by a user, such as computing device 104. Attention tracking application 108 hosted on server computing device 304 may be configured to receive attention tracking information from computing devices 106, to apply a function to the attention tracking information to generate a value, and to transmit the value to online conference application 114 hosted on computing device 104. With the value received from server computing device 304 (or attention tracking application 108), online conference application 114 hosted on computing device 104 may generate a graphical representation of the value in GUI 110 for display with image 112.

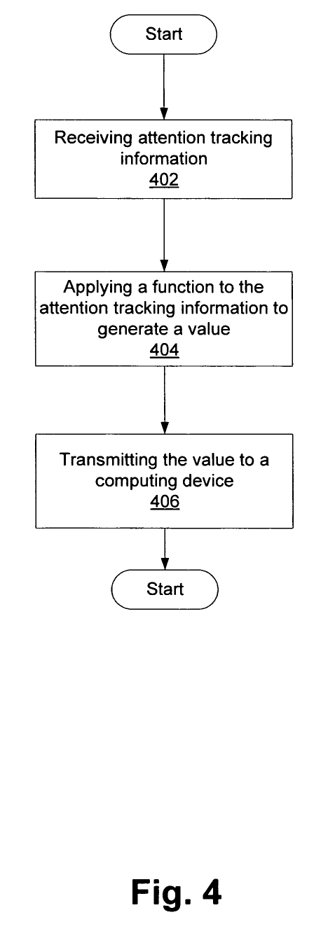

FIG. 4 is a flowchart diagram of a general overview for providing attention tracking information, in accordance with another embodiment. In the online conference system of FIG. 3, the attention tracking application may be hosted on a server computing device. In this embodiment, as shown in FIG. 4, the attention tracking application can receive attention tracking information in operation 402. In addition, the time associated with the attention tracking information may also be received along with the attention tracking information. Alternatively, attention tracking application may correlate a time with the attention tracking information.

In operation 404, a function may be applied to the attention tracking information to generate a value. In an embodiment, as explained above, the function may be a summation of the attention tracking information. In another embodiment, the function may include the division of the sum of the attention tracking information by a total number of online conference applications, which generates a percent value. After the value is generated, the value is transmitted to an online conference application hosted on a computing device in operation 406. The online conference application may then generate a graphical representation of the value over a time period.

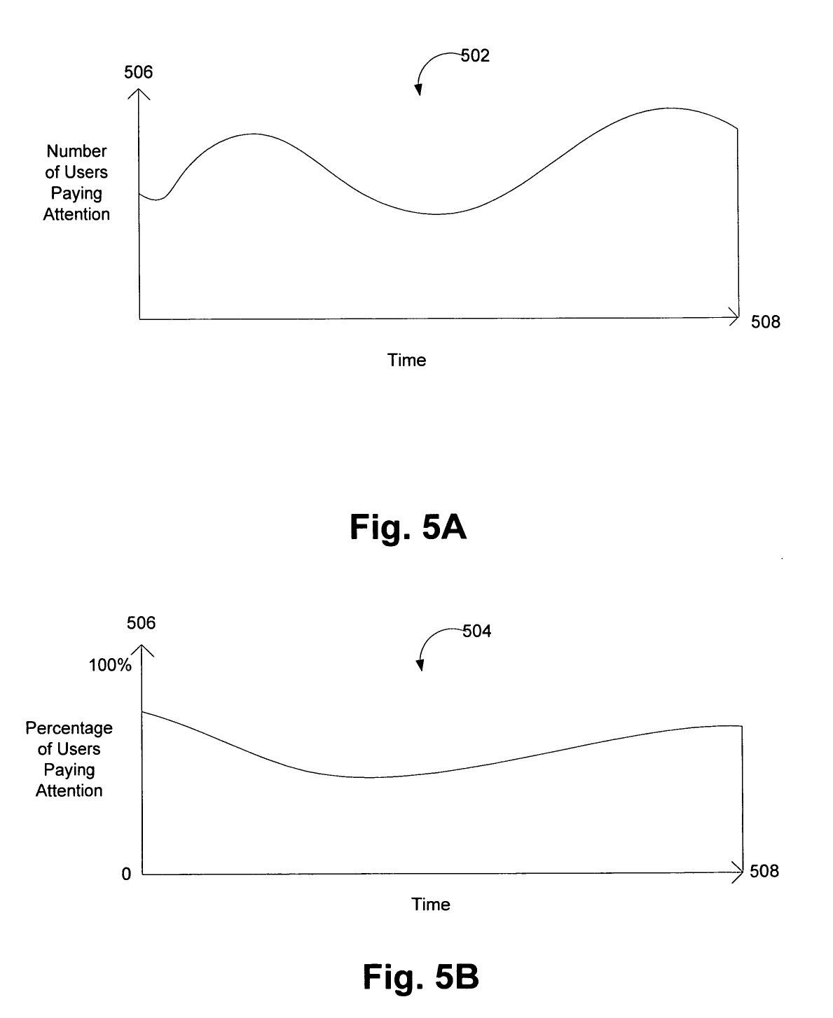

FIGS. 5A and 5B are various embodiments of GUIs configured to provide attention tracking information. As shown in FIG. 5A, GUI 502 includes a region that is configured to define a graph. The graph is configured to define values associated with attention tracking information over a time period. In the example of FIG. 5A, the graph shows the number of users that are or have paid attention to the online conference. The graph is defined by vertical axis 506 and horizontal axis 508. The time period may define the coordinates along horizontal axis 508. The time period may span from the beginning to the end of an online conference, where time increases from left to right along horizontal axis 508. The generated values that are based on the attention tracking information may define the coordinates along vertical axis 506. In FIG. 5A, each value can be defined as the sum of the attention tracking information at a particular time. In other words, the values along vertical axis 506 define the total number of users that are or are not paying attention to the online conference. In embodiments that use the placement of the online conference application to determine whether a user is paying attention to the online conference, the values along vertical axis 506 can be defined as a sum of online conference applications displayed in the foreground or background.

In an alternative embodiment, as shown in FIG. 5B, the values along vertical axis 506 may define the percentage of users that are or have paid attention to the online conference. In FIG. 5B, the time period defines the coordinates along horizontal axis 508. The values along vertical axis 506 define a percent value that increases from bottom to top. In the embodiment that uses the placement of online conference applications to determine whether a user is paying attention, the values along vertical axis 506 may be defined as a proportion between a sum of online conference applications displayed in a foreground or a background and a total number of online conference applications in an online conference.

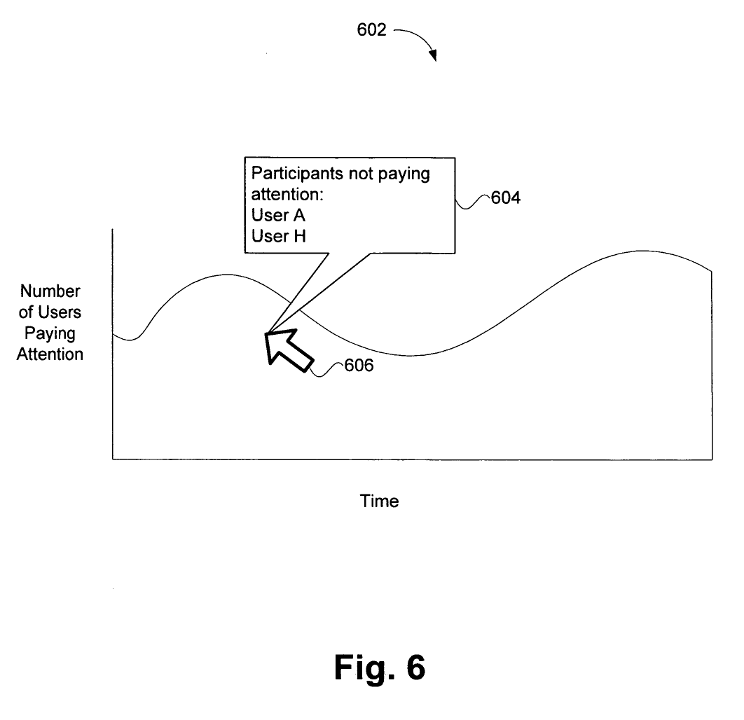

FIG. 6 is a diagram of a GUI configured to provide attention tracking information and other information, in accordance with an embodiment. As shown in FIG. 6, GUI 602 includes a first region that is configured to define a graph. The graph illustrates the total number of users that are or have paid attention to the online conference over a time period. In addition to the first region, GUI 602 may also include second region 604 that is configured to provide other information. Second region 604 may be generated in response to a selection of the first region. For example, a user may select a particular time within the graph by using cursor 606. Cursor 606 points to a point within the graph. The time is the coordinate along the horizontal axis that corresponds to the selected point. As a result, the selection of the time triggers the display of second region 604. As illustrated in FIG. 6, second region 604 shows the identifiers associated with users of the online conference, namely “User A” and “User H.” The identifier can be a symbol, a number, a character, and/or other data that establishes the identity of a user, an online conference application, or a computing device in the online conference.

Second region 604 may also show the identifiers associated with users that are not or are paying attention to the online conference. In an embodiment, the identifier may be associated with the attention tracking information. Accordingly, an attention tracking application may receive both attention tracking information and identifier from an online conference application. With the identifier, the attention tracking application may relate the attention tracking information to a particular user, online conference, or computing device. In other words, the attention tracking application may use the identifier to identify the source of the attention tracking information. In addition to identifiers, second region 604 may also display other information, such as the connectivity between two computing devices in an online conference, the duration of the attention span, whether other applications are triggered or executed, and other information.

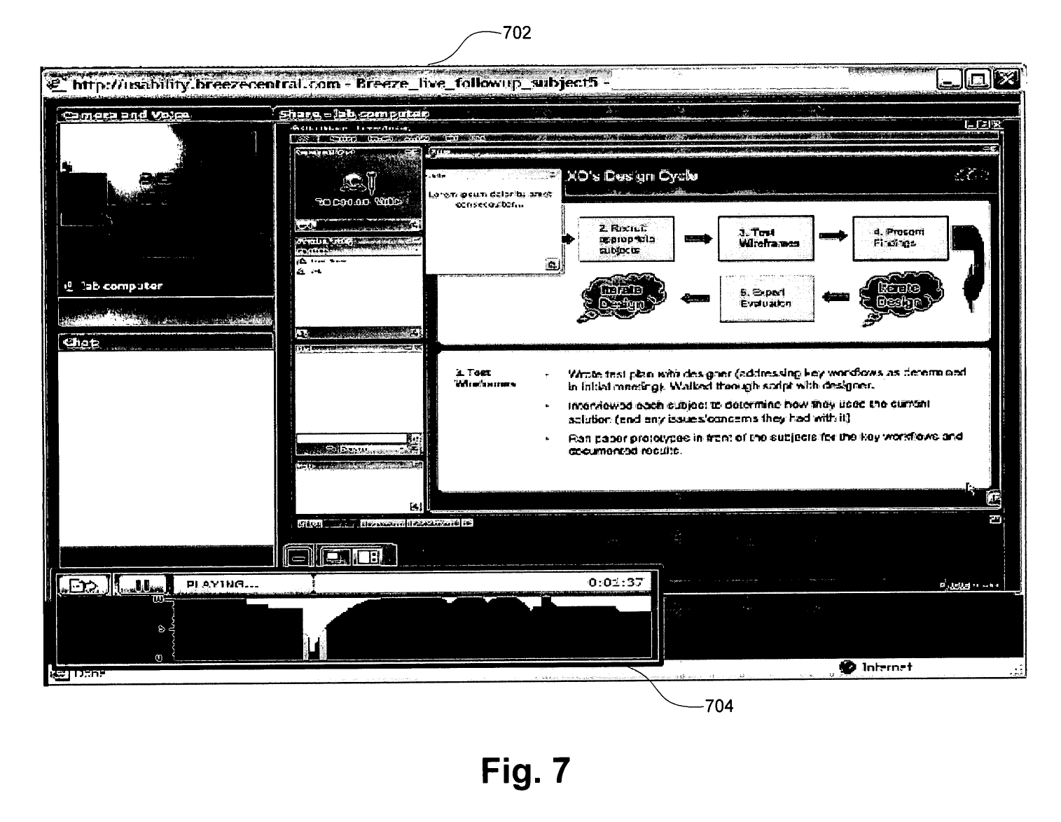

FIG. 7 is a diagram of a GUI displayed by an online conference application, in accordance with an embodiment. GUI 702 includes regions that display video, shared documents, chat dialog, and other information associated with or shared in an online conference. GUI 702 also includes region 704 that is configured to show a graphical representation of the attention tracking information over a time period. As shown in FIG. 7, region 704 includes a graph of the percent of users that are or have paid attention to the online conference over a time period. The graph includes a horizontal axis and a vertical axis. The percent values define the coordinates along the vertical axis and the time defines the coordinates along the horizontal axis.

In an embodiment, the images displayed in GUI 702 may be stored or recorded. In other words, the images outputted and displayed by the online conference application may be stored. The images may be stored on a server computing device or a computing device accessed by the user for the online conference. The user may use region 704 to retrieve the stored images. For example, each image displayed during the online conference corresponds to a time. As discussed above, a user may select a particular time within region 704 by using a cursor. The selection of the time triggers the display of an image that was displayed by the online conference at the selected time. The user may therefore access stored images associated with the online conference by interfacing with region 704. As a result, the user may play back the online conference from a point in time selected from region 704.

It should be appreciated that a variety of suitable layouts can be designed for region layouts illustrated above as FIGS. 5A, 5B, 6, and 7 do not represent all possible layout options available. The displayable appearance of the regions can be defined by a variety suitable geometric shapes (e.g., rectangle, square, circle, triangle, and other shapes), alphanumeric characters (e.g., A,v,t,Q,1,9,10, and other characters), symbols (e.g., $,*,@,▾,□,¤,♡, and other symbols), shadings, patterns (e.g., solid, hatch, stripes, dots, and other patterns), and colors. Furthermore, for example, second region 604 shown in FIG. 6, or other regions, may be omitted or dynamically assigned. It should also be noted that the regions can be fixed or customizable. In addition, the computing devices displaying the GUIs may have a fixed set of layouts, utilize a defined protocol or language to define a layout, or an external structure can be reported to the computing device that defines a layout. Further, clicking on a region of GUI as discussed above triggers code to cause the functionality described herein.

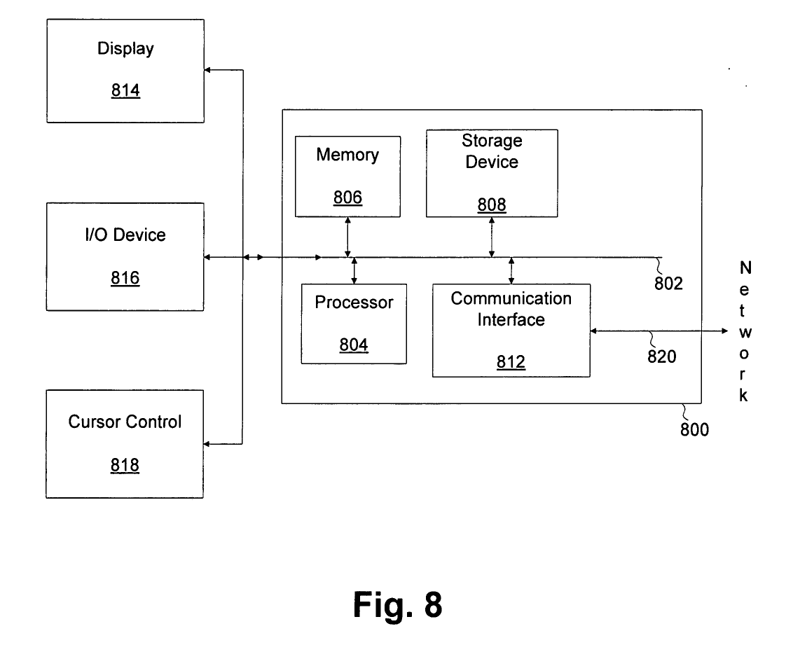

FIG. 8 is a simplified block diagram of an exemplary computer system that is suitable for processing and executing an online conference application and an attention tracking application, in accordance with an embodiment. In some embodiments, computer system 800 may be used to implement computer programs, logic, applications, methods, processes, or other software to provide information associated with communication latency. Exemplary computer system 800 includes a desktop computer, a server, a portable computing device, a personal digital assistant, a computational engine within an appliance, and other computer systems. As shown in FIG. 8, computer system 800 includes bus 802 or other communication mechanism for communicating information, which interconnects subsystems and devices, such as processor 804, system memory 806 (e.g., random access memory (RAM)), storage device 808 (e.g., read only memory (ROM), magnetic disk drives, optical disk drives, and other storage devices), communication interface 812 (e.g., modem or Ethernet card), display 814 (e.g., cathode ray tube (CRT) or liquid crystal display (LCD)), input/output device 816 (e.g., keyboard), and cursor control 818 (e.g., mouse or trackball).

In some embodiments, computer system 800 performs specific operations by processor 804 when executing one or more sequences of one or more program instructions stored in system memory 806. Such program instructions may be read into system memory 806 from another computer readable medium, such as storage device 808. In some embodiments, hard-wired circuitry may be used in place of or in combination with software program instructions to implement embodiments of the invention.

It should be appreciated that the term “computer readable medium” refers to suitable medium that participates in providing program instructions to processor 804 for execution. Such a medium may take many forms, including but not limited to, non-volatile media, volatile media, and transmission media. Non-volatile media may include, for example, optical or magnetic disks, such as storage device 808. Volatile media may include dynamic memory, such as system memory 806. Transmission media includes coaxial cables, copper wire, and fiber optics, including wires that comprise bus 802. Transmission media can also take the form of acoustic or light waves, such as those generated during radio wave and infrared data communications. Common forms of computer readable media include, for example, magnetic mediums (e.g., floppy disk, flexible disk, hard disk, magnetic tape, and other magnetic mediums), optical mediums (e.g., compact disc read-only memory (CD-ROM) and other optical mediums), physical medium with patterns (e.g., punch cards, paper tape, any other physical mediums), memory chips or cartridges, carrier waves, (e.g., RAM, programmable read-only memory (PROM), erasable programmable read-only memory (EPROM), flash memory, and other memory chips or cartridges), and any other medium from which a computer can read.

In some embodiments, execution of the sequences of program instructions to practice the embodiments may be performed by a single computer system 800. In other embodiments, two or more computer systems, such as computer system 800, coupled by communication link 820 (e.g., local area network (LAN), public switched telephone network (PSTN), wireless network, and other communication links) may perform the sequence of program instructions to practice the embodiments in coordination with one another. In addition, computer system 800 may transmit and receive messages, data, and instructions, including program, i.e., application code, through communication link 820 and communication interface 812. Received program instructions may be executed by processor 804 as the program instructions are received, and/or stored in storage device 808, or other non-volatile storage for later execution.

The above-described embodiments provide methods, devices, GUIs, and systems for providing attention tracking information in an online conference. With the attention tracking information provided to a user in real-time during the online conference, the user can easily gauge whether other users are paying attention to him during the online conference. As a result, a user can immediately take corrective actions during the online conference in order to communicate his messages to the other users. For example, if the user sees from the graphical representation that a large percentage of users have not paid attention to him at a particular time, the user may repeat the message that was conveyed at that particular time later in the online conference. As a result, the display of the attention tracking information improves, for example, communication between users in an online conference.

Although the foregoing examples have been described in some detail for purposes of clarity of understanding, the embodiments are not limited to the details provided. There are many alternative ways of implementing the embodiments. The disclosed examples are illustrative and not restrictive.

1. A computer-implemented method, comprising:
receiving attention tracking information from a plurality of remote applications over a period of time, wherein the attention tracking information comprises respective successive attention indicators for each of the plurality of remote applications;
determining a plurality of attention levels each corresponding to a respective one of the plurality of remote applications, wherein for each of the plurality of remote applications, a current state of the attention level corresponding to the remote application is changed only when each of a plurality of consecutively received attention indicators for the remote application indicates a same state that is different than the current state of the attention level;
applying a function to the plurality of attention levels to generate a value; and
displaying a graphical representation of the value over a time period.

2. The computer-implemented method of claim 1, wherein said receiving, said determining, and said applying are performed by an attention tracking application, the method further comprising sending successive requests for the attention tracking information from the attention tracking application to one of the remote applications, wherein the remote application, in response to receiving each successive request, responds by transmitting the attention tracking information.

3. The computer-implemented method of claim 1, further comprising receiving an identifier associated with the attention tracking information, wherein said receiving an identifier comprises receiving a respective identifier for each of the plurality of remote applications with each successive attention indicator.

4. The computer-implemented method of claim 1, further comprising receiving a time associated with the attention tracking information, wherein said receiving a time comprises receiving a respective time for each successive attention indicator received from each of the plurality of remote applications.

5. The computer-implemented method of claim 1, further comprising correlating the attention indicators and the value with a time.

6. The computer-implemented method of claim 1, wherein the plurality of remote applications are online conference applications, and wherein the attention tracking information is configured to indicate whether one of the online conference applications is placed in a background.

7. The computer-implemented method of claim 1, wherein the plurality of remote applications are online conference applications, and wherein the attention tracking information is configured to indicate whether a window associated with one of the online conference applications is placed in a background.

8. The computer-implemented method of claim 1, wherein the applying the function to the plurality of attention levels further comprises summing the plurality of attention levels to generate the value.

9. The computer-implemented method of claim 1, wherein the applying the function to the plurality of attention levels further comprises:
summing the plurality of attention levels to generate a sum; and
dividing the sum by a total number of the plurality of remote applications to generate the value.

10. The computer-implemented method of claim 1, further comprising:
receiving a selection of a time; and
displaying additional information associated with the plurality of remote applications that corresponds with the time, wherein the additional information indicates one or more of the following for the selected time:
which users associated with the plurality of remote applications are paying attention;
which users associated with the plurality of remote applications are not paying attention;
connectivity with each computing device running one of the plurality of remote applications;
duration that a particular user associated with one of the plurality of remote applications has been paying attention; or
whether other applications are triggered or executed on a computing device running one of the plurality of remote applications.

11. A computer readable storage medium storing program instructions for:
receiving attention tracking information from a plurality of remote applications over a period of time, wherein the attention tracking information comprises respective successive attention indicators for each of the plurality of remote applications;
determining a plurality of attention levels each corresponding to a respective one of the plurality of remote applications, wherein for each of the plurality of remote applications, a current state of the attention level corresponding to the remote application is changed only when each of a plurality of consecutively received attention indicators for the remote application indicates a same state that is different than the current state of the attention level;
applying a function to the plurality of attention levels to generate a value; and
transmitting the value to a remote computing device.

12. The computer readable storage medium of claim 11, further comprising program instructions for sending successive requests for the attention tracking information to one of the remote applications, wherein the remote application, in response to receiving each successive request, responds by transmitting the attention tracking information.

13. The computer readable storage medium of claim 11, further comprising program instructions for receiving an identifier associated with the attention tracking information, wherein said receiving an identifier comprises receiving a respective identifier for each of the plurality of remote applications with each successive attention indicator.

14. The computer readable storage medium of claim 11, further comprising program instructions for receiving a time associated with the attention tracking information, wherein said receiving a time comprises receiving a respective time for each successive attention indicator received from each of the plurality of remote applications.

15. The computer readable storage medium of claim 11, further comprising program instructions for correlating the attention tracking information and the value with a time.

16. The computer readable storage medium of claim 11, wherein the value is an aggregate of the attention levels.

17. The computer-implemented method of claim 1, wherein said displaying comprises displaying a graphical user interface (GUI) comprising a first region configured to define a graph of the value over the time period.

18. The computer-implemented method of claim 17, wherein the graph is defined by a vertical axis and a horizontal axis.

19. The computer-implemented method of claim 18, wherein the value defines a coordinate along the vertical axis.

20. The computer-implemented method of claim 18, wherein the time period defines a coordinate along the horizontal axis.

21. The computer-implemented method of claim 17, wherein the plurality of remote applications are online conference applications, and wherein the value is defined as a sum of the online conference applications displayed in a foreground.

22. The computer-implemented method of claim 17, wherein the plurality of remote applications are online conference applications, and wherein the value is defined as a sum of the online conference applications displayed in a background.

23. The computer-implemented method of claim 17, wherein the plurality of remote applications are online conference applications, and wherein the value is defined as a proportion between a sum of the online conference applications being displayed in a foreground and a total number of the online conference applications in an online conference.

24. The computer-implemented method of claim 17, wherein the plurality of remote applications are online conference applications, and wherein the value is defined as a proportion between a sum of the online conference applications being displayed in a background and a total number of the online conference applications in an online conference.

25. The computer-implemented method of claim 1, wherein the plurality of remote applications are online conference applications, and wherein the attention tracking information is configured to indicate one or more of:
whether audio is muted for one of the online conference applications;
whether a video camera and facial recognition system at a computing device running one of the online conference applications has detected a user present at the computing device; or
whether a video camera and eye tracking system at a computing device running one of the online conference applications has detected a user looking at a monitor for the online conference application.

26. A computing device, comprising:
a memory configured to store an attention tracking application; and
a processor in communication with the memory, the processor being configured to execute the attention tracking application stored in the memory during a online conference, the attention tracking application comprising program instructions for:
receiving from a remote application over a period of time, successive attention indicators, a time associated with each successive attention indicator, and an identifier associated with each successive attention indicator;
determining an attention level for the remote application, wherein a current state of the attention level is changed only when each of a plurality of consecutively received attention indicators for the remote application indicates a same state that is different than the current state of the attention level;
applying a function to the attention level to generate a value, and
transmitting the value, the time, and the identifier to a remote computing device.

27. A computing device, comprising:
a memory configured to store an attention tracking application; and
a processor in communication with the memory, the processor being configured to execute the attention tracking application stored in the memory during a online conference, the attention tracking application comprising program instructions for:
receiving attention tracking information from a plurality of remote applications over a period of time, wherein the attention tracking information comprises respective successive attention indicators for each of the plurality of remote applications;
determining a plurality of attention levels each corresponding to a respective one of the plurality of remote applications, wherein for each of the plurality of remote applications, a current state of the attention level corresponding to the remote application is changed only when each of a plurality of consecutively received attention indicators for the remote application indicates a same state that is different than the current state of the attention level;
correlating each attention level with a time;
applying a function to the attention levels to generate a value; and
displaying a graphical representation of the value at the time.
